(19) United States
(12) Patent Application Publication
(10) Pub. No.: US 2014/0340316 A1
(43) Pub. Date: Nov. 20, 2014

(54) Feedback for Gestures

(71) Applicant: MICROSOFT CORPORATION, Redmond, WA (US)

(72) Inventors: Jiawei Gu, Shanghai (CN); Siyuan Fang, Zhengzhou City (CN); Hong Z. Tan, Beijing (CN)

(73) Assignee: Microsoft Corporation, Redmond, WA (US)

(21) Appl. No.: 13/893,554

(22) Filed: May 14, 2013

(51) Int. Cl. G06F 3/01; G06F 3/041

(52) U.S. Cl. CPC G06F 3/016; G06F 3/041
USPC 345/173

(57) ABSTRACT

In some examples, an electronic device may provide haptic output associated with a gesture for performing a task using the electronic device. For instance, one or more sensors of the electronic device may detect movement of a touch input within an area of a display corresponding to an area of a graphical user interface. In response to detecting movement of the touch input, one or more haptic feedback components may generate haptic output associated with a task, such as an operating system task. In some implementations, the haptic output changes surface friction of an area of the display during movement of the touch input, providing feedback and guidance for the user to successfully complete the task.

### BACKGROUND

Computers and other types of electronic devices typically present information to a user in the form of a graphical output on a display. Some electronic devices receive input from users through contact with the display, such as via a fingertip or stylus. A user may perform certain gestures using a fingertip in order to perform a task, such as moving a file or closing a computer program. When interacting with a graphical user interface of a computer via a fingertip or stylus, the user typically receives visual feedback and may also receive auditory feedback. However, even with these forms of feedback, it may be difficult for a user to learn how to perform gestures in order to accomplish different tasks. For example, despite some visual or auditory feedback, a user may have difficulty determining if a fingertip or stylus is making the appropriate movements to successfully perform a task. There is often little or no useful feedback provided to the user before, during, or after execution of a task. Thus, due to the variety of input gestures and the corresponding variety of tasks, a user may find it challenging to learn and to become proficient at performing various tasks via touch input.

### SUMMARY

This Summary is provided to introduce a selection of concepts in a simplified form that are further described below in the Detailed Description. This Summary is not intended to identify key or essential features of the claimed subject matter; nor is it to be used for determining or limiting the scope of the claimed subject matter.

Some implementations disclosed herein provide for haptic output associated with a gesture, such as for performing a task using a graphical user interface of an operating system, an application or other computer program. In some examples, one or more sensors may detect movement of a touch input and one or more haptic feedback components may generate a haptic output associated with a corresponding task. For instance, in response to detecting movement of a touch input within an area of a display corresponding to a portion of a graphical user interface, one or more feedback components may generate haptic output associated with a task. Further, in some implementations, the haptic output may simulate resistance associated with moving an object.

### BRIEF DESCRIPTION OF THE DRAWINGS

The detailed description is set forth with reference to the accompanying drawing figures. In the figures, the left-most digit(s) of a reference number identifies the figure in which the reference number first appears. The use of the same reference numbers in different figures indicates similar or identical items or features.

FIG. 1 is a block diagram illustrating select elements of an example electronic device according to some implementations.

FIG. 2 illustrates an example of a display for providing haptic output according to some implementations.

FIG. 3 illustrates an example of a display for providing haptic output according to some implementations.

FIG. 4 illustrates an example of employing an electronic device to perform a task using a touch input and haptic feedback according to some implementations.

FIG. 5 illustrates an example of employing an electronic device to perform a task using a touch input and haptic feedback according to some implementations.

FIG. 6 illustrates an example of employing an electronic device to perform a task using a touch input and haptic feedback according to some implementations.

FIG. 7 illustrates an example of employing an electronic device to perform a task using a touch input and haptic feedback according to some implementations.

FIG. 8 illustrates an example of employing an electronic device to perform a task using a touch input and haptic feedback according to some implementations.

FIG. 9 illustrates an example of employing an electronic device to perform a task using a touch input and haptic feedback according to some implementations.

FIG. 10 illustrates an example of employing an electronic device to perform a task using a touch input and haptic feedback according to some implementations.

FIG. 11 illustrates an example of employing an electronic device to perform a task using a touch input and haptic feedback according to some implementations.

FIG. 12 illustrates an example of employing an electronic device to perform a task using a touch input and haptic feedback according to some implementations.

FIG. 13 is a flow diagram of an example process of interacting with an electronic device using a touch input and haptic feedback according to some implementations.

FIG. 14 is a block diagram illustrating select elements of an example electronic device according to some implementations.

### DETAILED DESCRIPTION

### Feedback for Touch Input Gestures

The technologies described herein are generally directed toward providing feedback for touch input gestures. According to some implementations, in response to detecting movement of a touch input within an area of a display corresponding to an area of a graphical user interface, one or more feedback components may generate haptic output within the area of the display. As one example, the haptic output is associated with performing a task of an operating system or other task within a graphical user interface. In some implementations, the haptic output simulates resistance associated with moving an object. For example, the haptic output may cause an increase in surface friction associated with the touch input. Thus, the haptic output may provide guidance and feedback to assist a user in performing the task successfully.

Some examples are described in the environment of performing tasks within an interface of an operating system. However, implementations are not limited to performing tasks within an operating system interface, but may be extended to any graphic interface that uses touch input gestures similar to those described herein. As an example, a variety of tasks may be performed within an operating system. Such tasks may include, for example, opening and closing menus or control panels, moving file or folder icons on a desktop, opening programs, or closing programs. Consequently, a variety of input gestures may be used, wherein each input gesture corresponds to a different operating system task. Due to the variety of input gestures, visual feedback may not provide an adequate amount of feedback to guide a user to successfully perform a task. Therefore, generating haptic output that corresponds to the task and that occurs in conjunction with the visual feedback provides an additional type of feedback to further assist the user in performing and completing the task. Additional forms of feedback may also be provided in conjunction with the visual and haptic output. For example, audio feedback may be provided. Thus, multi-modal guidance via graphical output, haptic output, and in some cases audio output, may be more beneficial in assisting a user when performing operating system tasks.

According to some implementations herein, an electronic device may include one or more sensors for detecting movement of a touch input within an area of a display corresponding to an area of the graphical user interface. The movement of a touch input is for performing a task, such as an operating system task. The electronic device generates a graphical output associated with the task, in response to detecting the movement of a touch input. The electronic device may also include one or more feedback components for generating haptic output associated with the task within the area of the display, in response to detecting the movement of the touch input. The haptic output may include a variety of different types of output, as described herein.

In some examples, in response to detecting the movement of touch input, the electronic device determines that the touch input is associated with performing a task, such as an operating system task. In response to determining that the touch input is associated with the task, the electronic device generates graphical output and haptic output.

According to some implementations herein, the electronic device may also include a processor, an audio component, and one or more additional components to provide for operation of the graphical user interface.

### Example Electronic Device

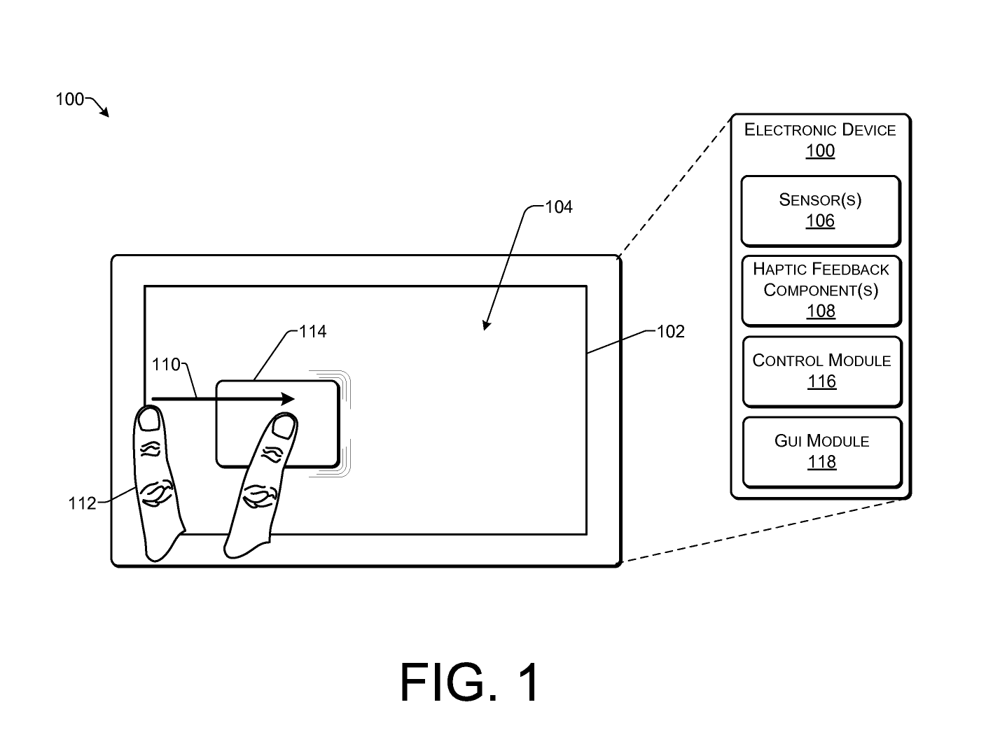

FIG. 1 is a block diagram illustrating selected elements of an example electronic device 100 according to some implementations. The electronic device 100 may be any type of device having a touch sensitive display 102 for presenting a graphical user interface 104. As several examples, the electronic device 100 may be a tablet computing device, a laptop computing device, a desktop computing device, a cellular phone or smart phone, a video game device, a television or home electronic device, an automotive electronic device, a cash register, a navigation device, and so forth.

In the illustrated example, electronic device 100 includes one or more sensors 106 and one or more haptic feedback components 108. The sensor 106 and the haptic feedback component 108 may be embedded within the display 102 or otherwise integrated with the electronic device 100 in a way suitable for detecting a touch input 110 and generating a haptic output. In some implementations, the sensor 106 may be separate from the display, such as in a touch pad or other input device. In some implementations, the haptic output may be physically localized within an area of the display 102 that includes the touch input 110.

The sensor 106 provides inputs that enable the electronic device 100 to accurately detect and track movement of the touch input 110. The touch input 110 may be provided by a user's finger 112, a stylus, and any other object suitable for entering a touch input into electronic device 100. Thus, although the finger 112 is used as an example herein, any other body part, stylus, or object suitable for providing the touch input 110 may be used instead of the finger 112. Haptic feedback component 108 may include one or more components operable for providing haptic output to a user providing the touch input 110 and movement of the touch input 110 to electronic device 100. For example, as described in further detail below, haptic feedback component 108 may simulate a change in a surface friction associated with the touch input 110. Thus, haptic feedback component 108 may induce a haptic output to simulate a change in the surface friction associated with the touch input 110 in order to simulate interaction with physical objects. For example, the haptic feedback component 108 may increase the surface friction within an area receiving movement of the touch input 110 in order to simulate resistance associated with moving a physical object. Thus, the force required to move a graphical object 114 on the graphical user interface 104 may be increased. In some examples, the haptic feedback component 108 may subsequently decrease the surface friction within the area, decreasing the force required to move the graphical object 114. In some examples, the electronic device 100 may also provide feedback to a user in conjunction with and contemporaneously with graphical output and haptic output.

The electronic device 100 may include various modules and functional components for performing the functions described herein. In some implementations, the electronic device 100 may include a control module 116 for controlling operation of the various components of the electronic device 100, such as the sensor 106 and the haptic feedback component 108. For example, the control module 116 may detect and register the touch input 110 and movement of the touch input 110 through the sensor 106. In response to the detecting, the control module 116 may generate haptic output through the haptic feedback component 108. Furthermore, a GUI module 118 may generate graphical output for the graphical user interface 104 in response to the detecting. In some examples, the functions performed by the control module 116 and the GUI module 118, along with other functions, may be performed by one module. Additional aspects of the control module 116 and the GUI module 118 are discussed below.

### Example Displays

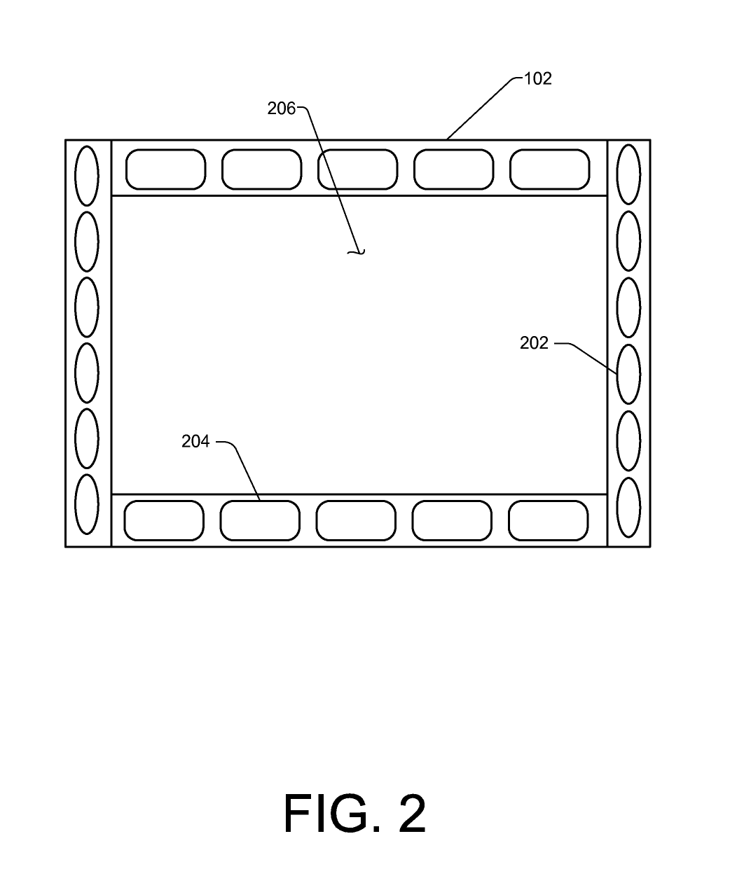

FIG. 2 illustrates an example of the display 102 for providing haptic output according to some implementations. In the example, the surface of the display 102 is made of glass. However, any other material suitable for use with a touch-based graphical user interface may be used. The surface friction of the glass can be modulated (increased and decreased) using actuators 202 and 204, such as piezoelectric actuators, capable of inducing vibrations and other haptic feedback on the display surface 206 at a variable and controllable rate. In some implementations, the vibrations and other haptic feedback are induced in certain portions of the display 102. For example, vibrations and other haptic feedback may be induced on a portion of the display surface 206 that receives the touch input 110, while vibrations and other haptic feedback are not induced on other portions of the display surface 206. In some implementations, vibrations and other haptic feedback may be induced on the entire display surface 206. As described herein, the other haptic feedback may include one cycle of a shaped pulse that is designed to simulate a mechanical key-click sensation. In some implementations, the actuators 202 or the actuators 204 induce both vibrations and other haptic feedback, only vibrations, or only the haptic feedback. In the example, the actuators 202, 204 are placed along and under the edges of the surface 206. In some examples, the actuators 202, 204 are hidden along or near the edges of the display 102. For example, the actuators 202, 204 may be hidden underneath bezels (not shown in FIG. 2).

In the illustrative example, the actuators 202 along the left and right side of the display 102 are driven at a frequency to move the surface 206 toward and away from the finger 112. Thus, the movement is along a direction normal to the plane of the surface 206. The movement traps a thin layer of air between the finger 112 and the surface 206 to create a squeeze air film effect. The squeeze air film effect reduces the friction between the finger 112 and the surface 206. The frequency may be an ultrasonic frequency of about 35 kHz or any other frequency suitable for creating the squeeze air film effect.

By changing the amplitude of the ultrasonic vibration of the surface 206, the surface friction between the finger 112 and the surface 206 can be increased or decreased. Thus, as the finger 112 moves along the surface 206 of the display 102 to produce the touch input 110, the user can feel the friction of the surface 206 changing. The change in friction may be perceived by the user as a change in resistive force or a change in the surface texture. In the illustrative example, actuators 204 along the top and bottom edges of the display 102 are driven by a one-cycle 500 Hz signal to generate a movement on at least a portion of the display to create a key-click sensation for a user, such as the shaped pulse described above. Thus, display 102 generates a haptic output that interacts with the finger 112 to simulate a clicking movement. The frequency may be any frequency suitable for generating a movement pattern sufficient for a user to detect (e.g., to simulate a key-click).

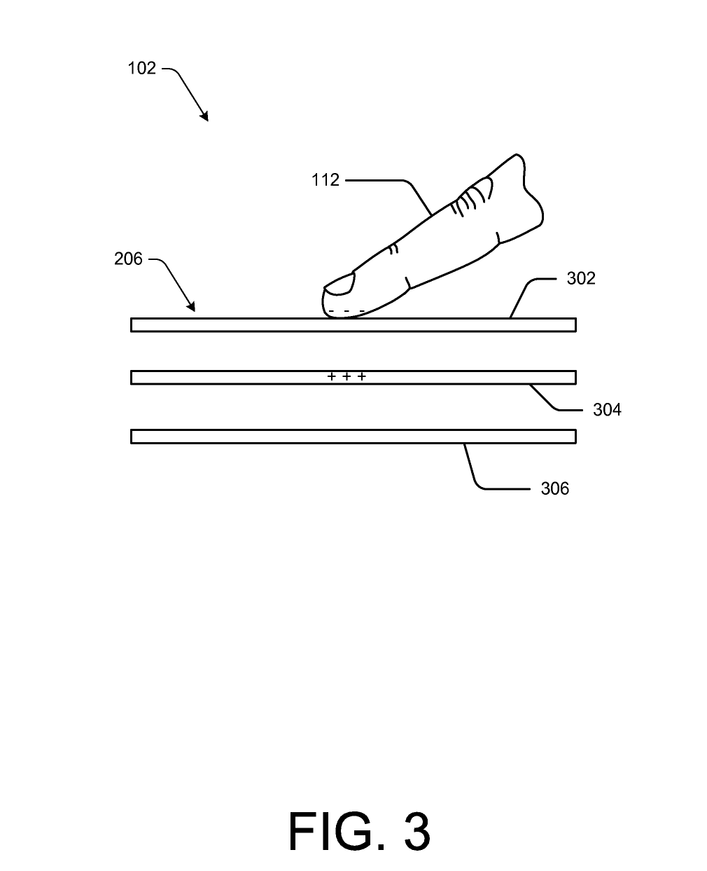

FIG. 3 illustrates an example cross section of a display, such as the display 102, for providing haptic output according to some implementations. In the example, a side view of the display 102 is shown. As in the previous example, the surface of the display 102 is made of glass. However, any other material suitable for use in a touch-based graphical user interface may be used.

In the illustrative example, the display 102 includes an insulating layer 302 as the display surface 206 that comes into contact with the finger 112, a conducting layer 304, and a glass layer 306. When an electrical signal is applied to the conducting layer 304, the signal induces opposite charges on the finger 112. In the illustrative example, a positive charge in the conducting layer 304 induces a negative charge in the finger 112.

The friction force, f, may be determined based on the following equation:

f=μ·(F_{f}+Fₑ)

where μ is the friction coefficient of the surface, F_{f} is the normal force the finger 112 exerts on the glass from pressing down, and Fₑ is the electric force due to the capacitive effect between the finger 112 and the conducting layer 304. As the electrical signal strength changes, Fₑ changes, resulting in changes in the friction force. Therefore, the user attributes changes in the friction force to changes in μ, causing an increase or decrease of surface friction, which may cause the illusion of a change in roughness of an otherwise smooth surface.

Interaction with the Graphical User Interface

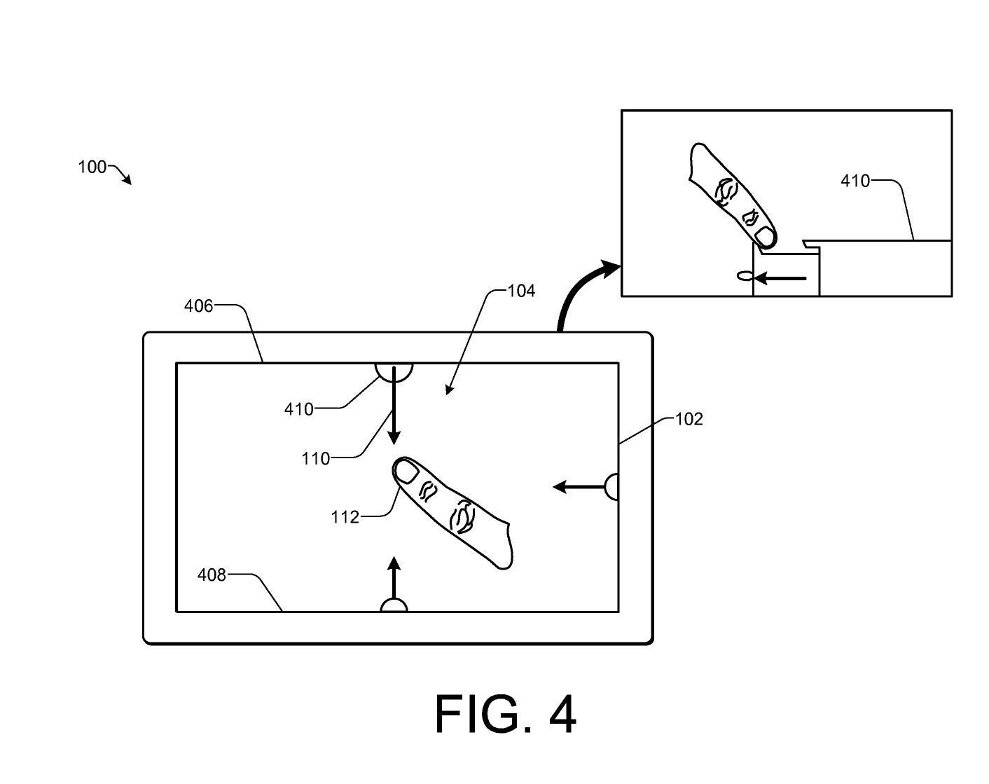

FIG. 4 illustrates an example of employing the electronic device 100 to perform a task according to some implementations. The display 102 presents the graphical user interface 104. The graphical user interface 104 has four sides, including a side 406 and an opposite side 408. The area 410 is a portion of the area of the display 102 that receives the touch input 110. In some examples, the area 410 may be an area of the display 102 that extends from the side 406 or is closer to the side 406 than any of the other sides of the graphical user interface 104.

When the finger 112 moves along the display 102 from the side 406 towards the opposite side 408, the sensor 106 detects movement of the touch input 110 within the area 410. In response to detecting the movement, the graphical user interface 104 generates graphical output associated with a task and the haptic feedback component 108 generates haptic output associated with the task.

In the example, the haptic output includes increasing surface friction within the area 410. The haptic output may also include subsequently a decrease in surface friction within the area 410. The graphical output may simulate movement of a menu bar, panel, or other graphical object in the direction of the movement of the touch input 110. Increasing and subsequently decreasing surface friction may simulate inertia associated with pulling a drawer 410, because less force is required to pull the drawer 410 after the drawer 410 begins moving.

In some examples, the surface friction along or near the side 406 is increased in order to simulate resistance associated with a physical obstacle, such as a bezel or ridge. Thus, the increased surface friction may hint at the possibility to drag something (e.g., a drawer). In some examples, haptic feedback component 108 may simultaneously generate vibrations and other haptic feedback (e.g., a shaped pulse) within area 406. Furthermore, electronic device 100 may simultaneously generate sound. Any of the above examples may be used alone or in combination to provide feedback for performing a task, such as dragging out a menu bar of the operating system, opening a system command panel, opening an application navigation commands panel, or switching between applications running in the background. In the illustrative example, the side 406 is the top side and the opposite side 408 is the bottom side of the graphical user interface 104, but other examples may instead use any other side and corresponding opposite side of the graphical user interface 104.

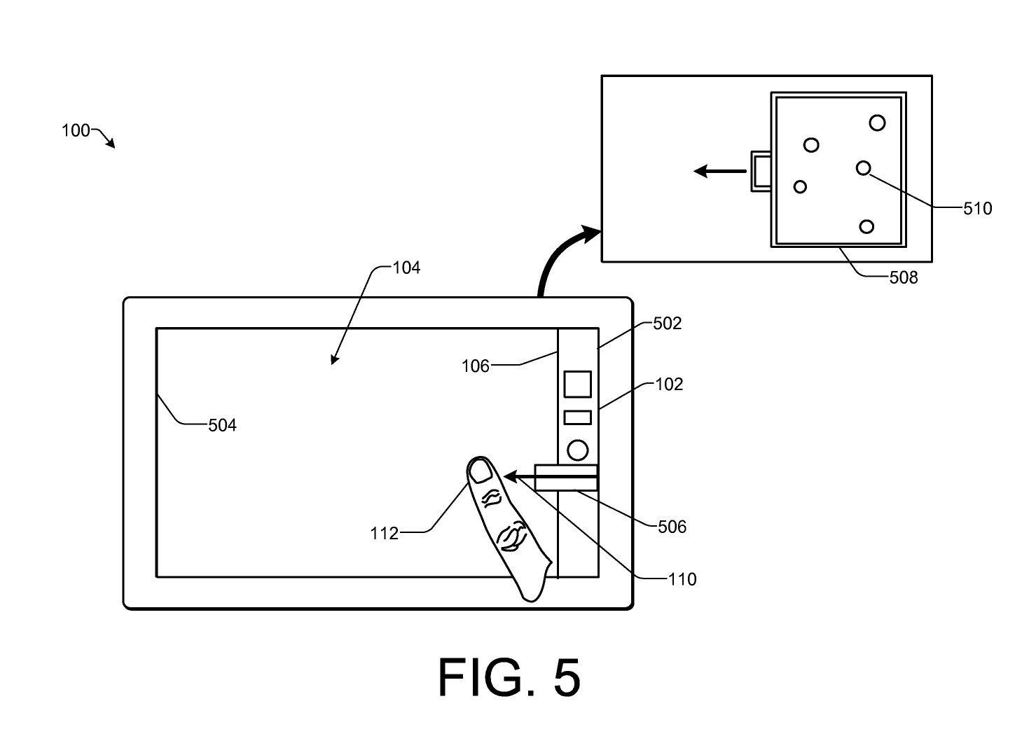

FIG. 5 illustrates an example of employing electronic device 100 to perform a task according to some implementations. In the example, the graphical user interface 104 has four sides, including side 502 and opposite side 504. The area 506 is a portion of the area of the display 104 that receives the touch input 110. In some examples, the area 506 may be an area of the display 102 that extends from the side 502 or is closer to the side 502 than any of the other sides of the graphical user interface 104.

When the finger 112 moves along the display 102 from the side 502 towards the opposite side 504, sensor 106 detects movement of the touch input within the area 506. In response to detecting the movement, the graphical user interface 104 generates graphical output associated with a task and the haptic feedback component 108 generates haptic output associated with the task.

In the example, the haptic output includes increasing surface friction within the area 506. The graphical output may include movement of a command panel or other graphical object in the direction of the movement of the touch input 110. In some examples, the surface friction may alternately increase and decrease as the touch input 110 moves within the area 506. In some examples, the haptic feedback component 108 may simultaneously generate vibrations and other haptic feedback (e.g., a shaped pulse) within the area 506. Furthermore, electronic device 100 may simultaneously generate sound. Thus, the surface friction may be used to simulate opening a drawer 508 with loose items 510. In some implementations, haptic output is generated in other areas of the display 102. For example, haptic feedback component 108 may simultaneously generate vibrations and other haptic feedback (e.g., a shaped pulse) within the area 506 and another area of the display 102 that may be in contact with a hand or other body part. Thus, a user may also receive haptic output with another hand that may be holding the electronic device 100. Any of the above examples may be used alone or in combination to provide feedback for any suitable task, such as opening a system command panel, dragging out a menu bar of the operating system, opening an application navigation commands panel, switching between applications, and moving graphical objects. In the illustrative example, the side 502 is the right side and the opposite side 504 is the left side of the graphical user interface 104, but other examples may instead use any other side and corresponding opposite side of the graphical user interface 104.

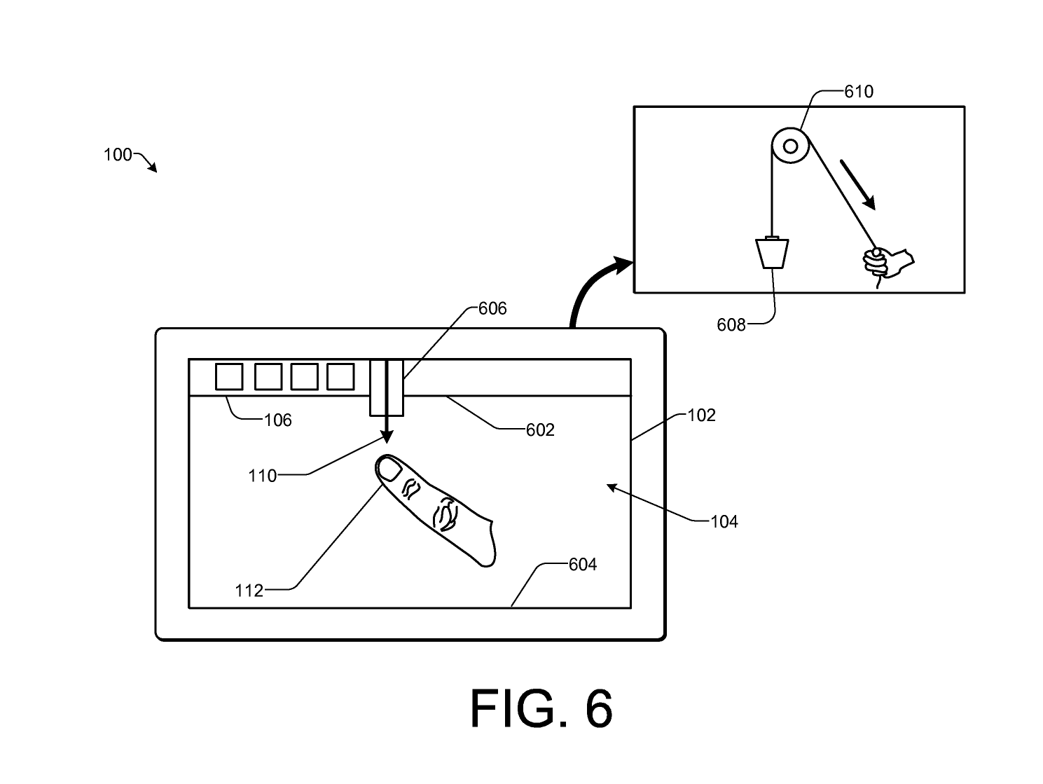

FIG. 6 illustrates an example of employing the electronic device 100 to perform a task according to some implementations. In the example, the graphical user interface 104 has four sides, including the side 602 and the opposite side 604. Area 606 is a portion of the area of the display 102 that receives the touch input 110. In some examples, the area 606 may be an area of the display 102 that extends from the side 602 or is closer to the side 602 than any of the other sides of the graphical user interface 104.

When the finger 112 moves along the display 102 from the side 602 towards the opposite side 604, the sensor 106 detects movement of the touch input 110 within the area 606. In response to detecting the movement, the graphical user interface 104 generates graphical output associated with a task and the haptic feedback component 108 generates haptic output associated with the task.

In the example, the haptic output includes increasing surface friction within the area 606 to a level and maintaining the level of the surface friction during the movement of the touch input 110. Thus, the surface friction may be used to simulate pulling an object 608 through a pulley 610 or lifting an object in a similar manner. The graphical output may include opening a command panel or moving a graphical object. In some implementations, haptic output is generated in other areas of the display 102. For example, haptic feedback component 108 may simultaneously generate vibrations and other haptic feedback (e.g., a shaped pulse) within the area 606 and another area of the display 102 that may be in contact with a hand or other body part. Thus, a user may also receive haptic output with another hand that may be holding the electronic device 100. For example, haptic output may be generated while a navigation bar or other graphical object moves along the graphical user interface 104, allowing a holding hand to feel vibrations and other haptic feedback.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 602 is the top side and the opposite side 604 is the bottom side of the graphical user interface 104, but other examples may instead use any other side and corresponding opposite side of the graphical user interface 104.

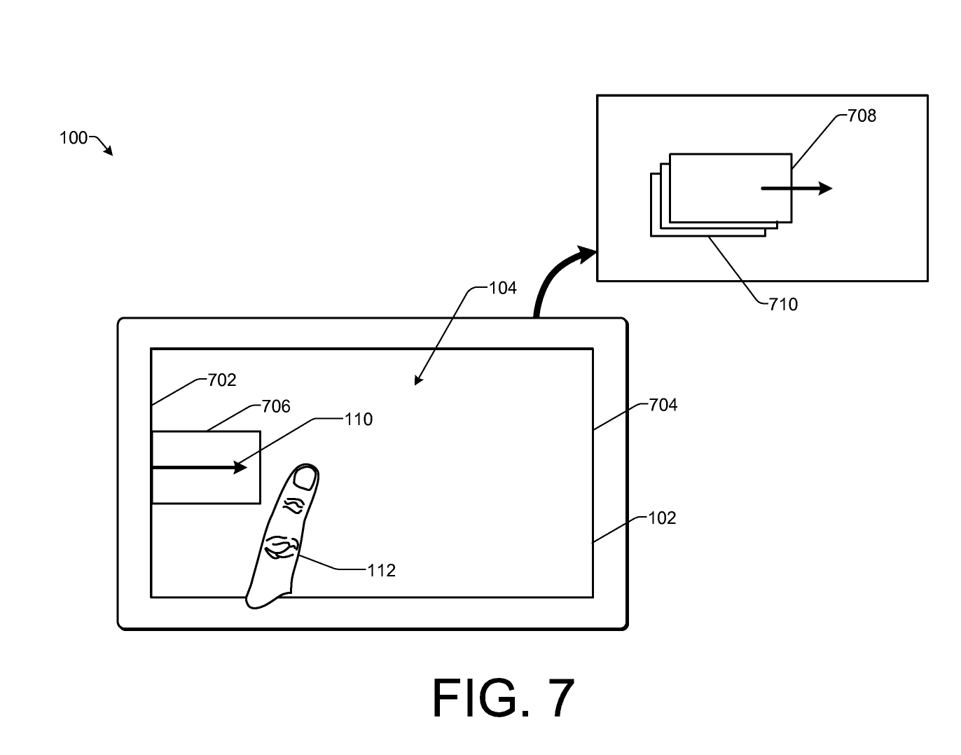

FIG. 7 illustrates an example of employing the electronic device 100 to perform a task according to some implementations. In the example, the graphical user interface 104 has four sides, including the side 702 and the opposite side 704. Area 706 is a portion of the area of the display 102 that receives the touch input 110. In some examples, the area 706 may be an area of the display 102 that extends from the side 702 or is closer to the side 702 than any of the other sides of the graphical user interface 104.

When the finger 112 moves along the display 102 from the side 702 towards the opposite side 704, the sensor 106 detects movement of the touch input 110 within the area 706. In response to detecting the movement, the graphical user interface 104 generates graphical output associated with a task and the haptic feedback component 108 generates haptic output associated with the task.

In the example, the haptic output includes increasing surface friction within the area 706 to a first level, then decreasing the surface friction to a second level, then decreasing the surface friction to a third level during the movement of the touch input 110. Thus, the surface friction may be used to simulate flicking a card 708 from the top of a deck of cards 710. The graphical output may include moving application icons or moving another graphical object. In some examples, the task performed is to switch among background applications.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 702 is the top side and the opposite side 704 is the bottom side of the graphical user interface 104, but other examples may instead use any other side and corresponding opposite side of the graphical user interface 104.

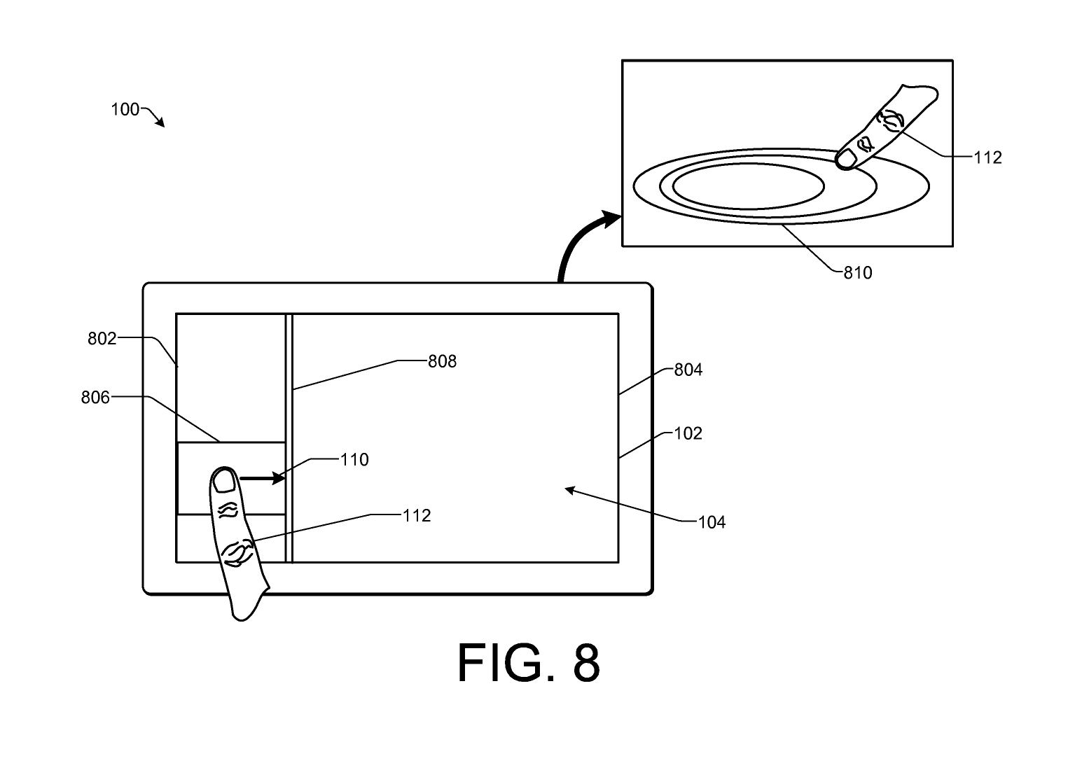

FIG. 8 illustrates an example of employing the electronic device 100 to perform a task according to some implementations. In the example, the graphical user interface 104 has four sides, including the side 802 and the opposite side 804. Area 806 is a portion of the area of the display 102 that receives the touch input 110. In some examples, the area 806 may be an area of the display 102 that extends from the side 802 or is closer to the side 802 than any of the other sides of the graphical user interface 104.

When the finger 112 moves along the display 102 from the side 802 towards the opposite side 804, the sensor 106 detects movement of the touch input 110 within the area 806. In response to detecting the movement, the graphical user interface 104 generates graphical output associated with a task and the haptic feedback component 108 generates haptic output associated with the task.

In the example, the haptic output includes generating vibrations and other haptic feedback (e.g., a shaped pulse) on at least a portion of the display 102 during the movement of the touch input 110. In some examples, the haptic output may occur after the finger stops moving. The graphical output may include moving a slide bar 808 or moving another graphical object beneath the finger 112 in the direction of the movement of the touch input 110. Thus, the surface friction may be used to simulate ripples or waves 810 beneath the finger 112 as the slide bar 808 moves across the graphical user interface 104. In some examples, the task performed is to switch among background applications.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 802 is the left side and the opposite side 804 is the right side of the graphical user interface 104, but other examples may instead use any other side and corresponding opposite side of the graphical user interface 104.

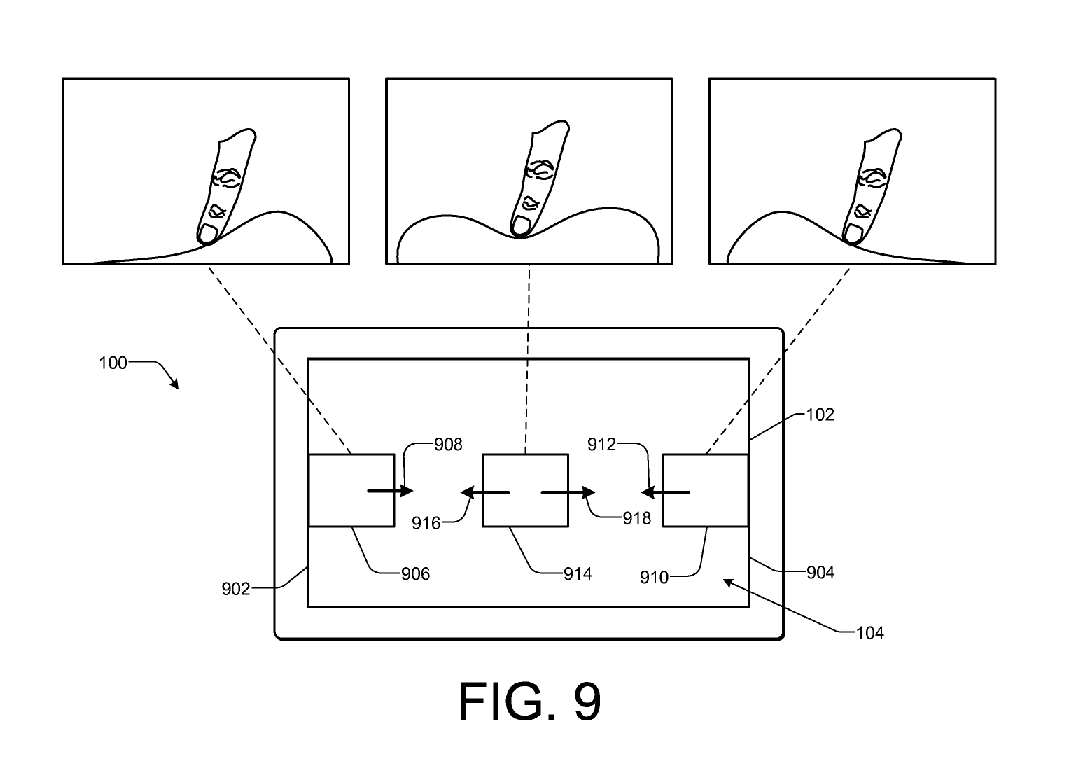

FIG. 9 illustrates an example of employing the electronic device 100 to perform a task according to some implementations. In the example, the graphical user interface 104 has a left side 902 and a right side 904.

Area 906 is an area of the display 102 that corresponds to a graphical object. Area 906 receives movement of the touch input 908 towards right side 904. In some examples, the graphical object may be an application icon. The sensor 106 detects the movement of the touch input 110 within the area 906. In response to detecting the movement, the graphical user interface 104 generates graphical output associated with a task and the haptic feedback component 108 generates haptic output associated with the task. In the example, the haptic output includes increasing the surface friction. In some examples, the haptic output includes increasing the surface friction in proportion to an amount of distance of the movement. The graphical output may include moving the graphical object in the direction of the touch input (e.g., to the right). Thus, the surface friction may be used to simulate squeezing or pushing away from the center of the graphical user interface 104.

Area 910 is an area of the display 102 that corresponds to a graphical object. Area 910 receives movement of the touch input 912 towards left side 902. In some examples, the graphical object may be an application icon. The sensor 106 detects the movement of the touch input 110 within the area 910. In response to detecting the movement, the graphical user interface 104 generates graphical output associated with a task and the haptic feedback component 108 generates haptic output associated with the task. In the example, the haptic output includes increasing the surface friction. In some examples, the haptic output includes increasing the surface friction in proportion to an amount of distance of the movement. The graphical output may include moving the graphical object in the direction of the touch input (e.g. to the left). Thus, the surface friction may be used to simulate squeezing or pushing away from the center of the graphical user interface 104.

Area 914 is an area of the display 102 that corresponds to a graphical object. Area 914 receives movement of a touch input 916 towards left side 902 or movement of a touch input 918 towards right side 904. In some examples, the graphical object may be an application icon. The sensor 106 detects the movement of the touch inputs within the area 914. In response to detecting a movement of touch input, the graphical user interface 104 generates graphical output associated with a task and the haptic feedback component 108 generates haptic output associated with the task. In the example, the haptic output includes increasing the surface friction. In some examples, the haptic output includes increasing the surface friction in proportion to an amount of distance of the movement. The graphical output may include moving the graphical object in the direction of the touch input. Thus, the surface friction may be used to simulate squeezing or pushing away from each side of the graphical user interface 104.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 902 is the left side and the opposite side 904 is the right side of the graphical user interface 104, but other examples may instead use any other side and corresponding opposite side of the graphical user interface 104.

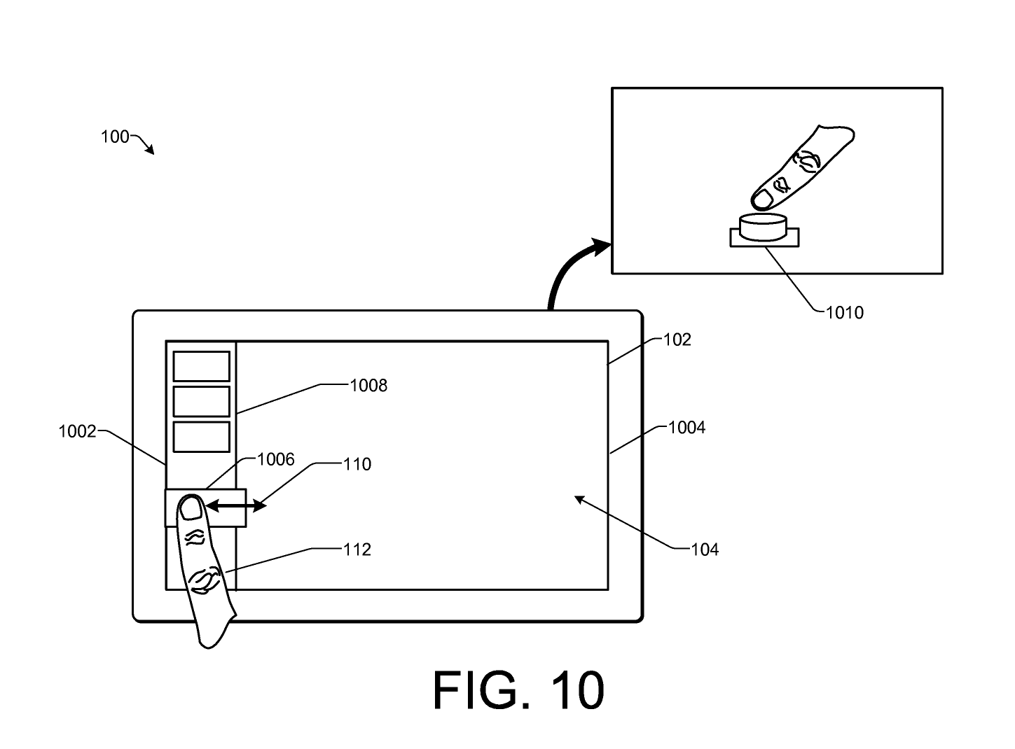

FIG. 10 illustrates an example of employing the electronic device 100 to perform a task according to some implementations. In the example, the graphical user interface 104 has four sides, including the side 1002 and the opposite side 1004. Area 1006 is a portion of the area of the display 102 that receives the touch input 110. In some examples, the area 1006 may be an area of the graphical user interface 104 that extends from the side 1002 or is closer to the side 1002 than any of the other sides of the graphical user interface 104.

When the finger 112 moves along the display 102 from the side 1002 towards the opposite side 1004 and back towards the side 1002, the sensor 106 detects movement of the touch input 110 within the area 1006. In response to detecting the movement, the graphical user interface 104 generates graphical output associated with a task and the haptic feedback component 108 generates haptic output associated with the task.

In the example, the haptic output includes generating vibrations and other haptic feedback (e.g., a shaped pulse) on at least a portion of the display 102 during the movement of the touch input 110. Thus, the surface friction may be used to simulate a click of a button 1010, punching a stapler, or similar sensation. The graphical output may include moving a panel 1008 or moving another graphical object into view. In some examples, the panel 1008 is a view of one or more application icons, such as in a multi-task preview mode. The graphical output may occur simultaneously with the haptic output. The graphical output and haptic output may occur during movement of the panel 1008 or after the panel appears and is stationary.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 1002 is the left side and the opposite side 1004 is the right side of the graphical user interface 104, but other examples may instead use any other side and corresponding opposite side of the graphical user interface 104.

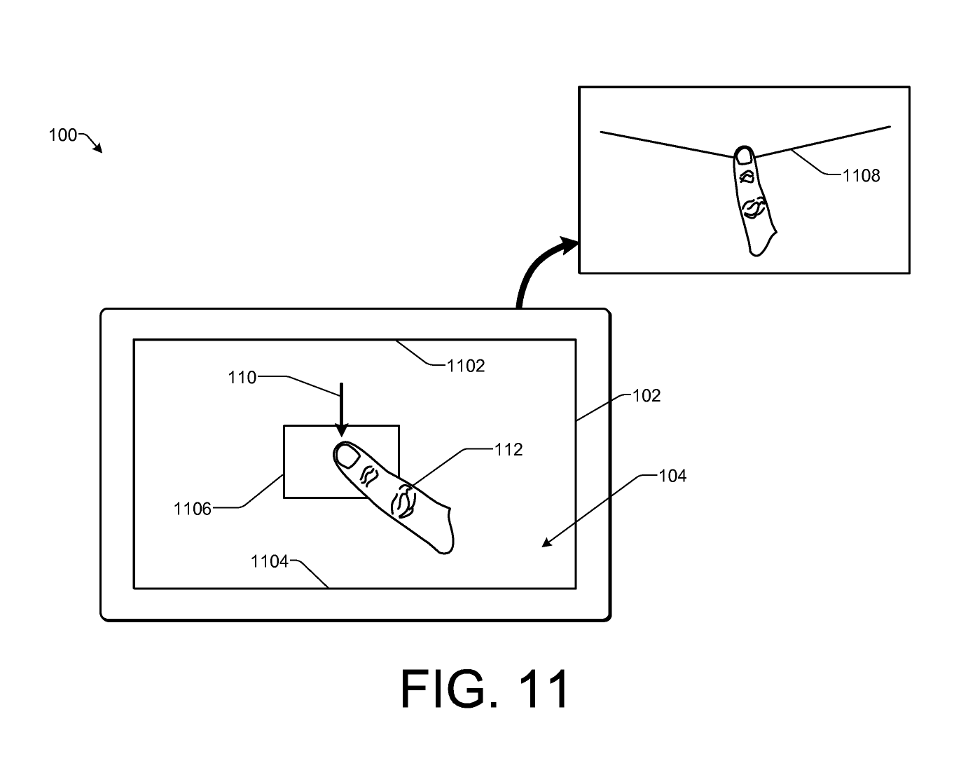

FIG. 11 illustrates an example of employing the electronic device 100 to perform a task according to some implementations. In the example, the graphical user interface 104 has four sides, including the side 1102 and the opposite side 1104. Area 1106 is a portion of the area of display 102 that receives the touch input 110. In some examples, the area 1106 may correspond to a graphical object, such as an application icon.

When the finger 112 moves along the graphical user interface 104 from the side 1102 towards the opposite side 1104, the sensor 106 detects movement of the touch input 110 within the area 1106. In some examples, the finger 112 begins movement from an area of the display 102 that is in between areas that correspond to the side 1102 and the opposite side 1104. In response to detecting the movement, the graphical user interface 104 generates graphical output associated with a task and the haptic feedback component 108 generates haptic output associated with the task.

In the example, the haptic output includes increasing surface friction within the area 1106 in proportion to a length of the movement of the touch input 110, causing the surface friction to increase as the finger moves towards the opposite side 1104. Thus, the surface friction may be used to simulate pulling or plucking on an elastic string 1108, such as a guitar string. The graphical output may include moving a graphical object in the direction of the movement of the touch input. For example, the area 1106 may correspond to a graphical object, such as an application icon. In some examples, when the touch input 110 is removed (e.g., the finger 112 is lifted), the graphical object moves back towards the side 1102. Furthermore, the graphical object may stay at the side 1102, change shape, change size, change color, or disappear.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 1102 is the top side and the opposite side 1104 is the bottom side of the graphical user interface 104, but other examples may instead use any other side and corresponding opposite side of the graphical user interface 104.

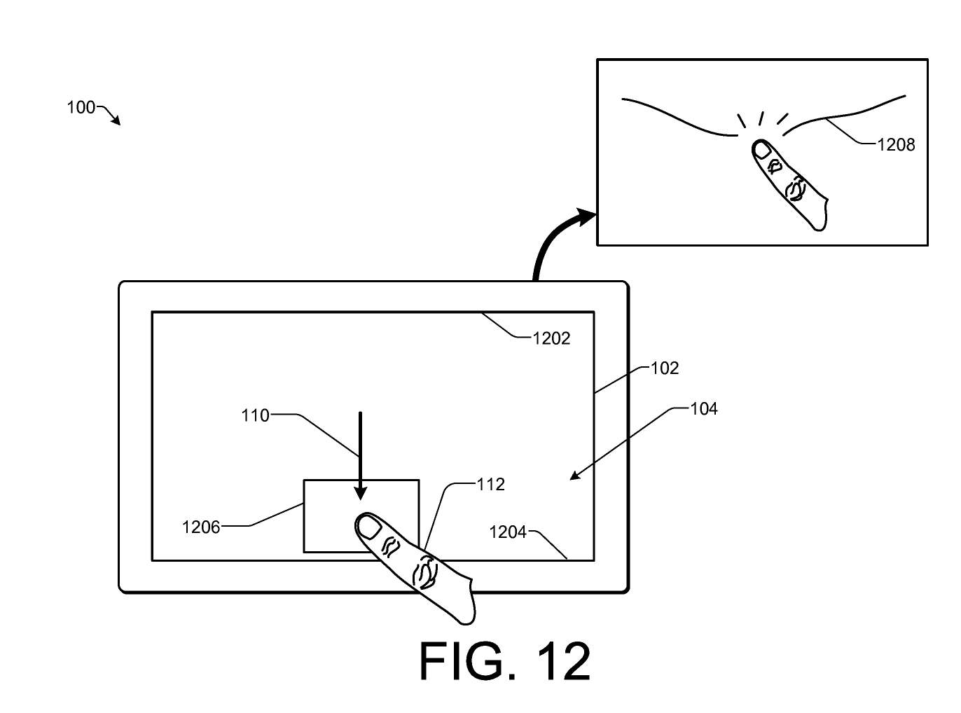

FIG. 12 illustrates an example of employing the electronic device 100 to perform a task according to some implementations. In the example, the graphical user interface 104 has four sides, including the side 1202 and the opposite side 1204. Area 1206 is a portion of the area of the display 102 that receives the touch input 110. In some examples, the area 1206 may correspond to a graphical object, such as an application icon.

When the finger 112 moves along the display 102 towards the opposite side 1204, the sensor 106 detects movement of the touch input 110 within the area 1206. In some examples, the finger 112 begins movement from the side 1202. In response to detecting the movement, the graphical user interface 104 generates graphical output associated with a task and the haptic feedback component 108 generates haptic output associated with the task.

In the example, the haptic output includes increasing surface friction within the area 1206 in proportion to a length of the movement of the touch input 110, causing the surface friction to increase as the finger moves towards the opposite side 1204. Thus, the surface friction may be used to simulate pulling or plucking on an elastic string 1208, such as a guitar string. The graphical output may include moving a graphical object in the direction of the movement of the touch input. For example, the area 1206 may correspond to a graphical object, such as an application icon.

In the example, in response to the touch input 110 moving past a threshold distance, the haptic output includes decreasing the surface friction. In some implementations, a large decrease in surface friction occurs, and the decrease in surface friction may occur immediately or suddenly. For example, the surface friction may return to approximately a lower level that existed as the finger began to move towards the opposite side 1204. Furthermore, the return to the lower level of surface friction may occur at a much faster rate than the rate of increase of surface friction occurred; in some cases, immediately or suddenly. Thus, the haptic output may simulate an elastic string breaking, such as breaking a guitar string. The haptic output may also include a vibration. Audio output may also occur simultaneously with the haptic and graphical output. Furthermore, the graphical object may move towards the opposite side 1204, change shape, change size, change color, or disappear. In some examples, the task may be closing an application.

Any of the above examples may be used alone or in combination to provide feedback for any suitable operating system task, such as dragging out a menu bar of the operating system, opening a system command panel, opening an application navigation commands panel, switching between applications, or dragging out an application window. In the illustrative example, the side 1202 is the top side and the opposite side 1204 is the bottom side of the graphical user interface 104, but other examples may instead use any other side and corresponding opposite side of the graphical user interface 104. Furthermore, any of the above examples of haptic, graphical, and audio output may be added or combined with any of the other examples of haptic, graphical, and audio output. Moreover, in any of the above examples, an increase in surface friction can be swapped with a decrease in surface friction and vice versa, in order to achieve a different haptic output response.

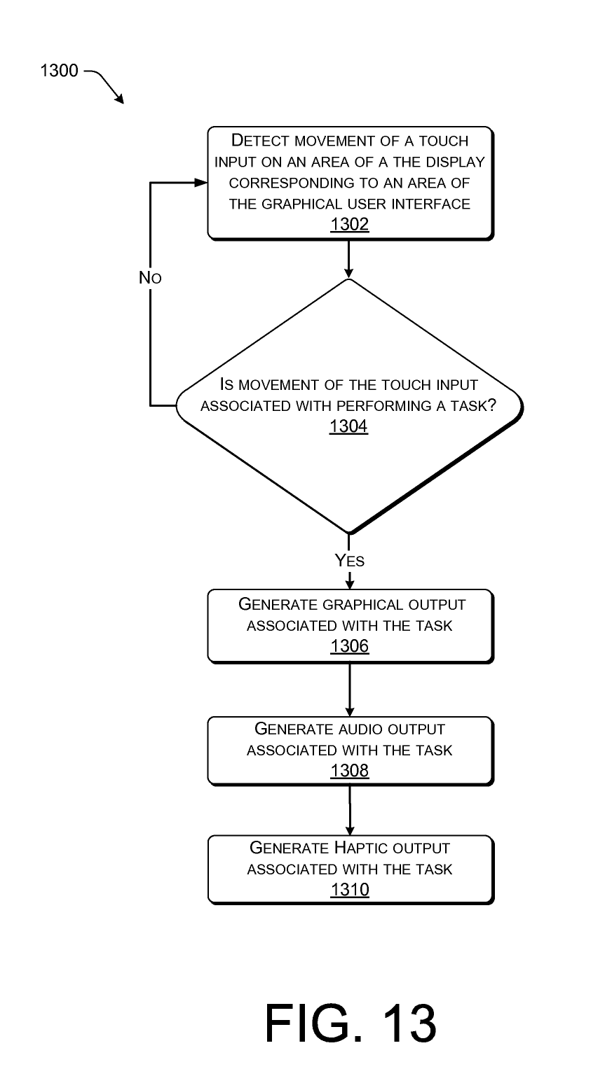

FIG. 13 is a flow diagram of an example process 1300 of interacting with the electronic device 100 according to some implementations. In the flow diagram, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, components, data structures, and the like that perform particular functions or implement particular abstract data types. The order in which the blocks are described is not intended to be construed as a limitation, and any number of the described operations can be combined in any order and/or in parallel to implement the process. For discussion purposes, the process 1300 is described with reference to the electronic device 100 of FIG. 1, although other devices, systems, frameworks, and environments may implement this process.

At block 1302, the sensor 106 detects movement of a touch input on an area of the display 102 corresponding to an area of the graphical user interface 104. For example, a user may swipe a finger from the top edge of the graphical user interface 104 down towards the bottom edge.

At block 1304, the electronic device 100 determines whether the movement of the touch input is associated with performing a task, such as a task of the operating system of electronic device 100. For example, the electronic device 100 may determine that the movement of a touch input is associated with displaying a menu bar on the graphical user interface 104. If the electronic device 100 determines that the movement of a touch input is not associated with a task of the operating system, then the method returns to step 1302 to detect any further touch input.

If the electronic device 100 determines that the movement of a touch input is associated with a task of the operating system, then at step 1306, the electronic device 100 generates graphical output associated with the task on the graphical user interface 104. For example, the graphical user interface 104 may generate a display of a menu bar. At step 1308, the electronic device 100 generates audio output associated with the task. For example, the electronic device 100 may generate a sound as the menu appears. At step 1310, the electronic device 100 generates haptic output associated with the task within the area of the display 102 corresponding to the area of the graphical user interface 104. For example, haptic feedback component 108 may increase surface friction within the area of the display 102 corresponding to the area of the graphical user interface 104. Steps 1306, 1308, and 1310 may occur simultaneously or at least partially at the same time. For example, haptic output may occur while graphical output occurs and while audio output occurs. While several examples are described herein for explanation purposes, the disclosure is not limited to the specific examples, and can be extended to additional devices, environments, applications and settings.

### Example Electronic Device

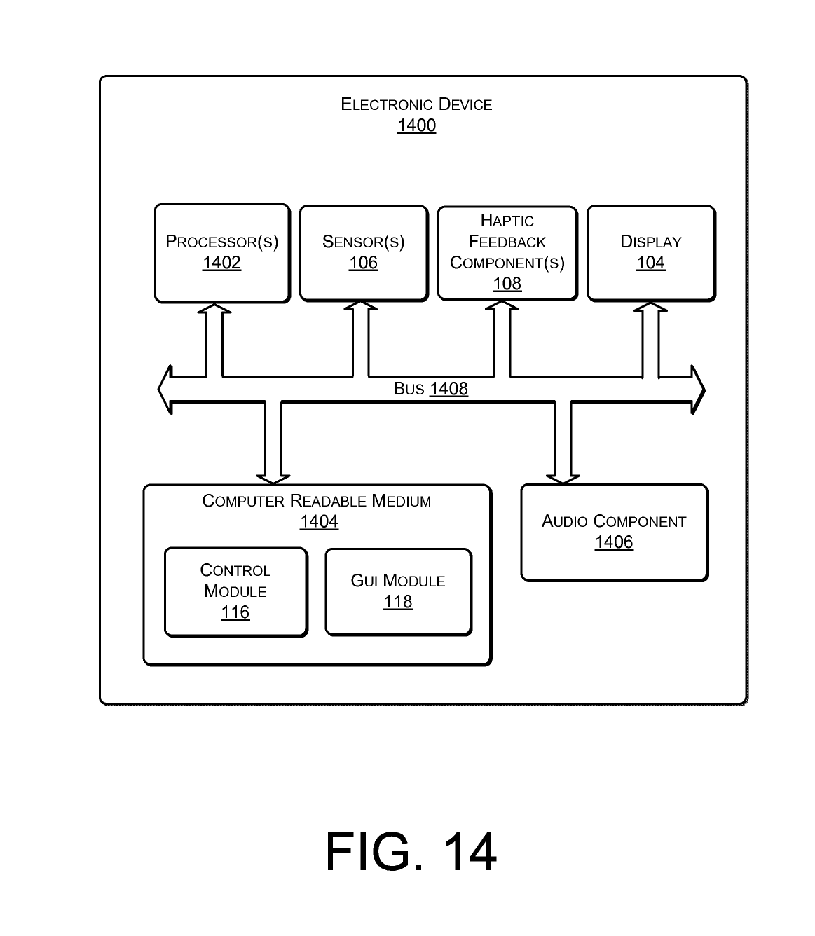

FIG. 14 is a block diagram illustrating selected elements of an example electronic device 1400 according to some implementations. The electronic device 1400 is an example of the electronic device 100 of FIG. 1. Thus, the electronic device may be any type of device having a touch sensitive display 102 for presenting a graphical user interface 104. In the illustrated example, the electronic device 1400 includes one or more processors 1402, one or more computer-readable media 1404 that includes the control module 116 and the GUI module 118, an audio component 1406, the one or more sensors 106, the one or more haptic feedback components 108, and the display 104, all able to communicate through a system bus 1408 or other suitable connection. Audio component 1406 may generate audio output in conjunction with or simultaneously with the haptic and graphical outputs discussed above.

In some implementations, the processor 1402 is a microprocessing unit (MPU), a central processing unit (CPU), or other processing unit or component known in the art. Among other capabilities, the processor 1402 can be configured to fetch and execute computer-readable processor-accessible instructions stored in the computer-readable media 1404 or other computer-readable storage media.

As used herein, “computer-readable media” includes computer storage media and communication media.

Computer storage media includes volatile and non-volatile, removable and non-removable media implemented in any method or technology for storage of information, such as computer-readable instructions, data structures, program modules, or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium that can be used to store information for access by a computing device.

In contrast, communication media may embody computer-readable instructions, data structures, program modules, or other data in a modulated data signal, such as a carrier wave. As defined herein, computer storage media does not include communication media.

Computer-readable media 1404 may include various modules and functional components for enabling the electronic device 1400 to perform the functions described herein. In some implementations, computer-readable media 1404 may include the control module 116 for controlling operation of the various components of the electronic device 100, such as sensor 106 and haptic feedback component 108. For example, the control module 116 may detect and register a touch input and movement of the touch input through sensor 106. In response to the detecting, the control module 116 may generate haptic output through haptic feedback component 108. Furthermore, as discussed above, the GUI module 118 may generate graphical output on the display 104 in response to the detecting. The control module 116 and/or the GUI module 118 may include a plurality of processor-executable instructions, which may comprise a single module of instructions or which may be divided into any number of modules of instructions. Such instructions may further include, for example, drivers for hardware components of the electronic device 100.

The control module 116 and/or the GUI module 118 may be entirely or partially implemented on the electronic device 100. Although illustrated in FIG. 1 as being stored in computer-readable media 1404 of electronic device 1400, the control module 116 and the GUI module 118, or portions thereof, may be implemented using any form of computer-readable media that is accessible by electronic device 1400. In some implementations, the control module 116 and/or the GUI module 118 are implemented partially on another device or server. Furthermore, computer-readable media 1404 may include other modules, such as an operating system, device drivers, and the like, as well as data used by the control module 116 and other modules.

Computer-readable media 1404 or other machine-readable storage media stores one or more sets of instructions (e.g., software) embodying any one or more of the methodologies or functions described herein. The instructions may also reside, completely or at least partially, within the computer-readable media 1404 and within processor 1402 during execution thereof by the electronic device 1400. The program code can be stored in one or more computer-readable memory devices or other computer-readable storage devices, such as computer-readable media 1404. Further, while an example device configuration and architecture has been described, other implementations are not limited to the particular configuration and architecture described herein. Thus, this disclosure can extend to other implementations, as would be known or as would become known to those skilled in the art.

The example environments, systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one example” “some examples,” “some implementations,” “the example,” “the illustrative example,” or similar phrases means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
presenting a graphical user interface on a display;
detecting movement of a touch input on an area the display corresponding to an area of the graphical user interface associated with performing a task; and
in response to the detecting:
generating a graphical output associated with the task; and
generating, within the area of the display, a haptic output associated with the task.

2. The method according to claim 1, wherein:
the area of the graphical user interface comprises a side area of the graphical user interface;
the movement is towards an opposite side of the graphical user interface; and
the haptic output comprises:
increasing a surface friction; and
subsequently decreasing the surface friction during the movement.

3. The method according to claim 1, wherein:
the area of the graphical user interface comprises a side area of the graphical user interface;
the movement is towards an opposite side of the graphical user interface; and
the haptic output increasing a surface friction and causing a vibration.

4. The method according to claim 1, wherein:
the area of the graphical user interface comprises a side area of the graphical user interface;
the movement is towards an opposite side of the graphical user interface; and
the haptic output comprises increasing a surface friction and maintaining a level of the surface friction during the movement.

5. The method according to claim 1, wherein:
the area of the graphical user interface comprises a side area of the graphical user interface;
the movement is towards an opposite side of the graphical user interface; and
the haptic output comprises changing a surface friction to a first level, changing the surface friction to a second level, and changing the surface friction to a third level during the movement.

6. The method according to claim 1, wherein:
the area of the graphical user interface comprises a side area of the graphical user interface;
the movement is towards an opposite side of the graphical user interface; and
the haptic output comprises a pulse on at least a portion of the display.

7. The method according to claim 1, wherein:
when the area of the graphical user interface comprises a left area or a right area of the graphical user interface, the haptic output comprises changing a surface friction when the movement is towards a center area of the graphical user interface; and
when the area of the graphical user interface comprises the center area of the graphical user interface, the haptic output comprises changing the surface friction when the movement is towards the left area or the right area of the graphical user interface.

8. The method according to claim 1, wherein:
the area of the graphical user interface comprises a side area of the graphical user interface;
the movement is towards and subsequently away from an opposite side of the graphical user interface; and
the haptic output comprises a pulse on at least a portion of the display.

9. The method according to claim 1, wherein:
the area of the graphical user interface comprises a side area of the graphical user interface;
the movement is towards an opposite side of the graphical user interface; and
the haptic output comprises increasing a surface friction in proportion to a length of the movement.

10. The method according to claim 9, wherein the haptic output further comprises decreasing the surface friction in response to the movement passing a threshold distance.

11. A device comprising:
a display to present a graphical user interface;
one or more sensors for detecting movement of a touch input corresponding to an area of the graphical user interface, wherein:
the touch input is associated with performing a task, and
the graphical user interface generates a graphical output associated with the task in response to the detecting; and
one or more haptic feedback components for generating, within the area of the display, a haptic output associated with the task in response to the detecting.

12. The device according to claim 11, wherein:
the area of the graphical user interface comprises a side area of the graphical user interface;
the movement is towards an opposite side of the graphical user interface; and
the haptic output comprises increasing and subsequently decreasing the surface friction during the movement or decreasing and subsequently increasing the surface friction during the movement.

13. The device according to claim 11, wherein:
the area of the graphical user interface comprises a side area of the graphical user interface;
the movement is towards an opposite side of the graphical user interface; and
the haptic output comprises changing a surface friction and maintaining a level of the surface friction during the movement.

14. The device according to claim 11, wherein:
the area of the graphical user interface comprises a side area of the graphical user interface;
the movement is towards an opposite side of the graphical user interface; and
the haptic output comprises a pulse on at least a portion of the display.

15. The device according to claim 11, wherein:
when the area of the graphical user interface comprises a left area or a right area of the graphical user interface, the haptic output comprises increasing a surface friction when the movement is towards a center area of the graphical user interface; and
when the area of the graphical user interface comprises the center area of the graphical user interface, the haptic output comprises increasing the surface friction when the movement is towards the left area or the right area of the graphical user interface.

16. The device according to claim 11, wherein the one or more sensors are one of: sensors in the display or sensors separate from the display.

17. A computer-readable medium storing computer-executable instructions that, when executed, cause one or more processors to perform acts comprising:
presenting a graphical user interface on a display;
detecting movement of a touch input on an area of the display corresponding to an area of the graphical user interface associated with performing a task;
determining that the movement of the touch input is associated with performing the task; and
in response to the determining:
generating a graphical output associated with the task, wherein the graphical output comprises moving one or more graphical objects in a direction of the movement of the touch input; and
generating, within the area of the display, a haptic output associated with the task, wherein the haptic output comprises changing a surface friction of the display.

18. The computer-readable medium of claim 17, wherein the area of the graphical user interface comprises a side area of the graphical user interface, the movement is towards an opposite side of the graphical user interface, and increasing the surface friction comprises increasing the surface friction in proportion to a length of movement of the touch input.

19. The computer-readable medium of claim 17, wherein the area of the graphical user interface comprises a side area of the graphical user interface, the movement is towards an opposite side of the graphical user interface, and the haptic output further comprises a pulse on at least a portion of the display.

20. The computer-readable medium of claim 17, wherein the area of the graphical user interface comprises a side area of the graphical user interface, the movement is towards an opposite side of the graphical user interface, and the haptic output further comprises increasing a surface friction in proportion to a length of the movement.
